(19) United States
(12) Patent Application Publication
(10) Pub. No.: US 2022/0056276 A1
(43) Pub. Date: Feb. 24, 2022

(54) Method for Producing Solid Particles, Solid Particles, and the Use Thereof

(71) Applicant: GEBRÜDER DORFNER GMBH & CO. KKAOTIN- UND KRISTALLQUARZSAND-WERKEKG, Hirschau (DE)

(72) Inventors: Erich OETZEL, Osnabrück (DE); Reinhard KRÄUTER, Sulzbach-Rosenberg (DE)

(21) Appl. No.: 17/432,862

(22) PCT Filed: Feb. 20, 2020
(86) PCT No.: PCT/EP2020/054561

§ 371 Date: Aug. 20, 2021

(30) Foreign Application Priority Data
Feb. 22, 2019 (DE) 10 2019 104 577.0

(51) Int. Cl. C09C 1/42; C01D 15/02; C22B 26/12; C22B 26/22

(52) U.S. Cl. CPC C09C 1/42; C01D 15/02; C22B 26/12; C22B 26/22; C01P 2006/62; C22B 3/06; C01P 2004/62; C01P 2004/61; C01P 2004/80; C01P 2004/03; C01P 2006/12

(57) ABSTRACT

The invention relates to a method for producing solid particles from an inorganic solid containing at least one alkali metal and/or alkaline earth metal, comprising at least the following steps:
a) providing the inorganic solid containing at least one alkali metal and/or alkaline earth metal;
b) extracting the at least one alkali metal and/or alkaline earth metal from the inorganic solid containing alkali metal and/or alkaline earth metal to obtain an extract containing the alkali metal and/or alkaline earth metal and an alkali metal-depleted and/or alkaline earth metal-depleted residue;
c) separating the extract from the residue;
d) processing the residue to obtain the solid particles, wherein at least one of the processing steps is selected from a group comprising transporting, filling, packaging, washing, drying, adjusting the pH value, separating according to a mean grain size and/or mass and/or density, adjusting a mean grain size, magnetic separating, calcining, thermal rounding and surface coating.

The present invention relates to a method for producing solid particles from an inorganic solid containing at least one alkali metal and/or alkaline earth metal. The invention also relates to such solid particles and to a use of such solid particles.

Alkali metals and alkaline earth metals do not occur naturally in nature, but only as components of compounds such as salts and minerals. In the prior art, they are obtained by processing inorganic solids containing alkali metal and/or alkaline earth metal, mostly ores, by means of an extraction (leaching), or by processing salt solutions from salars. When leaching ores, the alkali metal or alkaline earth metal to be extracted is usually dissolved with a suitable solvent and the solution (extract) containing alkali metal and/or alkaline earth metal is separated from the remaining insoluble solid, known as the residue. The alkali metal-depleted and/or alkaline earth metal-depleted residue, a so-called leach residue (also known as “leach tailings”), is usually not further processed or used, but is dumped on stockpiles as a waste product.

The ores contain only low concentrations of alkali metals and alkaline earth metals, which means that large amounts of residues are produced from the extraction. For this reason, these residues must be included in calculations as a cost factor.

It is therefore an object of the present invention to provide a residue that is obtained in an alkali metal and alkaline earth metal extraction from an inorganic solid containing at least one alkali metal and/or alkaline earth metal for further use or to produce a further product from the residue.

This object is achieved by a method for producing solid particles from an inorganic solid containing at least one alkali metal and/or alkaline earth metal, comprising at least the following steps:
a) providing the inorganic solid containing at least one alkali metal and/or alkaline earth metal;
b) extracting the at least one alkali metal and/or alkaline earth metal from the inorganic solid containing alkali metal and/or alkaline earth metal to obtain an extract containing the alkali metal and/or alkaline earth metal and an alkali metal-depleted and/or alkaline earth metal-depleted residue;
c) separating the extract from the residue;
d) processing the residue to obtain the solid particles, wherein at least one of the processing steps is selected from a group comprising transporting, filling, packaging, washing, drying, adjusting the pH value, separating according to a mean grain size and/or mass and/or density, adjusting a mean grain size, magnetic separating, calcining, thermal rounding and surface coating.

Extraction, also known as leaching, or a corresponding method/process, is hereinafter referred to as the separation or removal or depletion of components or substances to be isolated from a mixture, preferably a solids mixture, such as an ore comprising various minerals or rocks. The solids mixture is preferably brought together with a reactant after appropriate processing, which depends on various factors and is specified in more detail below, the substance to be isolated preferably being converted into a soluble form by the chemical reaction and it being possible to separate said substance from the solids mixture by means of a suitable solvent. The reactant and the solvent are advantageously chosen so that the substance to be isolated can be separated from the mixture as completely and selectively as possible. After separating the solution (extract), which advantageously contains the substance to be isolated in dissolved form, from the insoluble solid (residue), the solution can be processed further. In the process, undesired impurities which were also separated from the solids mixture in addition to the substance to be isolated are removed and the substance to be isolated can be obtained in a suitable form and with a preferred degree of purity. The depleted residue contains the components or substances that could not be converted into a soluble form by the extraction. The substance to be isolated is preferably an alkali metal and/or alkaline earth metal.

As already mentioned, the alkali metal-depleted and/or alkaline earth metal-depleted residue has previously not been used further and has only been stockpiled. The present invention ensures that the residue can be used further and that solid particles can be obtained therefrom, which in turn can also be used for the production of secondary products. Consequently, the residues from the alkali and/or alkaline earth extraction or the solid particles obtained therefrom after at least one processing step can serve as a cost-effective alternative to particles which have been specially mined and/or produced for this purpose.

The processing or the processing steps in accordance with step d) of the method can preferably be selected on the basis of the inorganic solid containing at least one alkali metal and/or alkaline earth metal or the residue and/or the desired properties of the solid particles.

Extraction and/or leaching methods are used, inter alia, to obtain alkali metals and/or alkaline earth metals, since these can easily be converted into a soluble form. The extraction of lithium, which is used to manufacture lithium-ion batteries, plays an important role in this case. When lithium is extracted, large amounts of lithium-depleted residues are produced.

Many different extraction and leaching methods are known from the prior art with regard to the type of process (e.g., acidic or basic), the conditions (temperature T, time t, pressure p), the number, sequence and type of method steps and the composition of the material from which the substance (in particular alkali metals and/or alkaline earth metals) is to be obtained. The aim of this method is identical, however, and is intended to be used for the extraction or recovery of the desired substance, in which case an alkali metal-depleted and/or alkaline earth metal-depleted residue remains. All known extraction and/or leaching methods that result in an alkali metal-depleted and/or alkaline earth metal-depleted residue within the meaning of the invention are advantageously intended to be disclosed, even if these are not explicitly mentioned below.

The extraction of alkali metals and/or alkaline earth metals from an inorganic material containing at least one alkali metal and/or alkaline earth metal is preferably carried out from ores which are first mined in deposits/mines. The inorganic solid containing alkali metal and/or alkaline earth metal or the ore preferably consists of a mixture of different minerals or rocks, at least one mineral/rock containing the alkali metal and/or alkaline earth metal to be extracted. The exact composition of the inorganic solid containing alkali metal and/or alkaline earth metal preferably differs depending on the location of the deposit and also on the mining site within the deposit.

The inorganic solids or minerals containing alkali metal and/or alkaline earth metal, from which the alkali metals and/or alkaline earth metals are obtained, preferably differ depending on the desired alkali metal and/or alkaline earth metal. The inorganic solids or minerals containing alkali metal and/or alkaline earth metal are preferably selected so that the alkali metals and/or alkaline earth metals can be separated by means of appropriate extraction processes and/or the inorganic solid containing alkali metal and/or alkaline earth metal or the mineral is available in sufficient quantity and as a coherent deposit. For example, lithium is obtained from zinnwaldite, lepidolite, spodumene and/or petalite. Nowadays, spodumene and petalite, which are both counted among pegmatites, and lepidolite are particularly preferred for the extraction of lithium. The inorganic solids or minerals containing alkali metal and/or alkaline earth metal which can be used for the extraction of lithium are not intended to be restricted to the examples mentioned. Furthermore, it is conceivable that the inorganic solids containing alkali metal and/or alkaline earth metal can occur as mixtures with other inorganic solids containing alkali metal and/or alkaline earth metal containing alkali metals and/or alkaline earth metals and/or other inorganic solids which do not contain any alkali and/or alkaline earth metals.

The preferred inorganic solids spodumene and petalite, which contain alkali metal and/or alkaline earth metal, are silicates. Spodumene has the chemical composition (LiAl)[Si₂O₆] or (Li₂O×Al₂O₃×4SiO₂) and is a chain silicate. Petalite, which is one of the tectosilicates, has the chemical composition (LiAl)[Si₄O₁₀] or (Li₂O×Al₂O₃×8SiO₂). The inorganic solid lepidolite containing alkali metal and/or alkaline earth metal has the general empirical formula K(Li,Al)₃[(F,OH)₂(Si,Al)₄O₁₀] and is one of the phyllosilicates. All inorganic solids containing alkali metal and/or alkaline earth metal that are cited as being preferred are based on an aluminium-silicon-oxygen structure (aluminium silicate). The lithium or Li₂O occupies free spaces within this structure or lattice.

Another example of an extraction is the leaching of magnesium from serpentine using hydrochloric acid. The inorganic solid serpentine containing alkaline earth metal or the inorganic solids containing alkali metal and/or alkaline earth metal which belong to the serpentine group are silicates.

Particularly preferred for the alkali metal-depleted and/or alkaline earth metal-depleted residue within the meaning of the invention are those which originate from ores or inorganic solids containing alkali metal and/or alkaline earth metal which comprise a silicate and in particular an aluminium silicate (aluminium-silicon-oxygen structure). However, the invention is not intended to be limited to such residues.

The inorganic solid containing at least one alkali metal and/or alkaline earth metal is preferably enriched prior to step a) in a first process (“concentration”) based on the at least one alkali metal and/or alkaline earth metal to be extracted, by separating undesired secondary rocks, the so-called gangue, by means of mechanical and/or hydromechanical methods and thus obtaining a concentrate. The first concentration process which preferably takes place can comprise methods known from the prior art such as breaking, separating, liberating, optical sorting, magnetic separation, density separation, cycloning, sieving, flotation and/or electrofragmentation. However, the methods for enriching the alkali metal and/or alkaline earth metal to be extracted in the inorganic solid containing at least one alkali metal and/or alkaline earth metal are not limited to these examples and can be used in various variations and/or combinations. The gangue can be quartz, feldspar and/or mica, for example.

The concentrate can preferably comprise particles with different mean grain sizes (d₅₀, Sedigraph). The mean grain size is preferably dependent, inter alia, on the methods used for the enrichment and on the planned subsequent steps, and can be adjusted accordingly. It is conceivable that the mean grain size is in a range of 1 μm-1 cm, 1 μm-5 mm, 1 μm-1 mm, 1 μm-500 μm, 1 μm-100 μm, 100 μm-500 μm, 500 μm-1 mm or 1 mm-5 mm. However, the mean grain size is not restricted to these values or ranges. The mean grain size can preferably be selected or adjusted in accordance with the following steps for alkali metal and/or alkaline earth metal extraction.

The degree of enrichment of the inorganic solid containing at least one alkali metal and/or alkaline earth metal after the first concentration process is preferably at least a factor of 1.5 based on the content of alkali metal and/or alkaline earth metal in the inorganic solid containing at least one alkali metal and/or alkaline earth metal before concentration. For example, the lithium oxide (Li₂O) content in ores (the inorganic solid containing at least one alkali metal and/or alkaline earth metal) is mostly between 1 and 3%. After enrichment, the Li₂O content in the concentrate is usually between 5 and 6.5%. Unless percentages or contents are defined differently in the following, these are to be understood as percentages by mass, based on the total mass.

The alkali metal and/or alkaline earth metal is preferably extracted (also known as leaching) from the inorganic solid (or optionally the corresponding concentrate) (“conversion”) containing at least one alkali metal and/or alkaline earth metal, which can also preferably be understood to mean breaking up or loosening the lattice structure of the mineral.

Steps a) and b) and/or steps c) and d) of the method according to the invention preferably take place separately from one another in space and/or time. However, it is also conceivable that the respective steps are carried out in direct succession.

Preferably, before and/or during step b), the inorganic solid containing at least one alkali metal and/or alkaline earth metal can first be activated by means of thermal methods such as calcination. The calcination can take place with the help of a shaft furnace, a rotary kiln, a tunnel furnace and/or a fluidised bed furnace. It is also conceivable that the calcination is a free-fall calcination and/or a short-term calcination with a preferred calcination time of <3 s. Hydrothermal methods are also preferably used to activate the inorganic solid containing at least one alkali metal and/or alkaline earth metal.

The thermal and hydrothermal methods for activating the inorganic solid containing at least one alkali metal and/or alkaline earth metal can preferably also be combined and carried out in parallel or in succession. Furthermore, the methods can be carried out with or without an acid, preferably as a pure substance or aqueous solution, as an aerosol or as a gas.

The optional activation of the inorganic solid containing at least one alkali metal and/or alkaline earth metal can preferably be carried out before the extraction at a temperature of 0-1500° C., 500-1300° C., 800-1250° C., 900-1150° C. or 1050-1100° C. It is conceivable that the temperature is kept constant or changed in the course of the activation. The list of possible activation temperatures is not intended to be exhaustive. The temperature is preferably adapted to the present inorganic solid containing at least one alkali metal and/or alkaline earth metal or the minerals contained therein. A mineral has a characteristic glass transition temperature above which it changes into an insoluble glass phase. The alkali metals and/or alkaline earth metals can only be extracted very poorly from the glass phase.

For example, the activation of spodumene in the extraction of lithium takes place preferably between 1050 and 1100° C. This results in a phase change from α-spodumene to β-spodumene. This phase change leads to a volume increase of approximately 20%. The phase change of α-spodumene to β-spodumene advantageously allows for a more efficient extraction of the lithium.

The duration of the activation or the activation time is preferably between 0.1 s and 24 h. In particular, all times within the specified range are advantageously also intended to be disclosed. However, the duration of the activation is not intended to be limited to these times. Furthermore, it is possible that, for the temperature change described above, different holding times can be provided for different temperatures.

The activation of the inorganic solid containing at least one alkali metal and/or alkaline earth metal or the concentrate thereof is preferably carried out at atmospheric pressure—300 bar pressure, with all pressure values within the range also advantageously being intended to be disclosed. It is conceivable that the pressure is kept constant or changed during activation. Furthermore, different holding times can be provided for different pressure values.

The optional methods or processes described above by way of example for concentrating the inorganic solid containing at least one alkali metal and/or alkaline earth metal before and/or after and/or during step a) of the method according to the invention or for activating the inorganic solid containing at least one alkali metal and/or alkaline earth metal before and/or during the extraction in step b) of the method according to the invention are merely preferred optional method steps.

Preferably, after the activation of the inorganic solid containing at least one alkali metal and/or alkaline earth metal, the extraction or leaching of the at least one alkali metal and/or alkaline earth metal from the inorganic solid containing at least one alkali metal and/or alkaline earth metal or preferably the activated concentrate thereof is carried out. Various leaching processes or methods are preferably known from the prior art and can be used. The leaching can, for example, be acidic or alkaline. The acid or the lye preferably reacts with the at least one alkali metal and/or alkaline earth metal to form a soluble, preferably water-soluble, alkali metal and/or alkaline earth metal compound which is separated from the inorganic solid containing at least one alkali metal and/or alkaline earth metal by means of a solvent, preferably water.

For acid leaching (extraction), preference is given to using hydrochloric acid HCl, nitric acid HNO₃, sulphuric acid H₂SO₄, phosphoric acid H₃PO₄, carbonic acid H₂CO₃, acetic acid C₂H₄O₂ and/or oxalic acid C₂H₂O₄, although the acids are not intended to be restricted to these examples. It is conceivable that the acids can be used as a pure substance and/or as an aqueous solution and/or as mixtures with themselves and/or other additives. The pH value during the acid leaching process is preferably 0-6.5. All intermediate values for the pH are also advantageously intended to be disclosed.

In extraction or leaching with bases, preference is given to using carbonates such as sodium carbonate Na₂CO₃, sodium hydrogen carbonate NaHCO₃, ammonium carbonate (NH₄)₂CO₃ and/or hydroxides such as calcium hydroxide Ca(OH)₂ or NaOH. The choice of bases is not intended to be restricted to the bases mentioned. The pH value during the base leaching process is preferably 8-14. All intermediate values for the pH are also advantageously intended to be disclosed.

The duration of the extraction process is preferably between 1 minute and 24 hours, 1 minute and 6 hours, 1 minute and 30 minutes, 1 hour and 6 hours, 30 minutes and 1 hour or 6 hours and 24 hours. In particular, all times within the specified ranges are also advantageously intended to be disclosed. However, the duration of the extraction process is not intended to be limited to these times.

The extraction process preferably takes place at temperatures in a range between 0-800° C., 0-30° C., 30-100° C., 100-300° C. or 300-800° C. In particular, all temperatures within the specified ranges are also advantageously intended to be disclosed. It is conceivable that the temperature is kept constant and/or changed during the extraction process. It is also possible for different holding times to be provided for different temperatures.

The extraction process of the inorganic solid containing at least one alkali metal and/or alkaline earth metal is preferably carried out at atmospheric pressure—300 bar pressure, with all pressure values within the range likewise advantageously being intended to be disclosed. It is conceivable that the pressure is kept constant or changed during activation. Furthermore, different holding times can be provided for different pressure values.

Consequently, a suspension is preferably present after/during the extraction process, the suspension comprising a solution, known as the extract, which contains the dissolved alkali metal and/or alkaline earth metal or the dissolved alkali metal and/or alkaline earth metal compound, and an undissolved alkali metal-depleted and/or alkaline earth metal-depleted solid, known as the residue. The extract and the residue are preferably separated from one another by means of methods known from the prior art. The solution is preferably processed further and the alkali metal and/or alkaline earth metal is ultimately obtained as a salt, preferably as a carbonate or hydroxide.

According to a preferred embodiment of the method according to the invention, the residue is a lithium-depleted and/or magnesium-depleted residue. More preferably, the residue comprises less than 7 mass %, preferably less than 5 mass %, more preferably less than 3 mass %, particularly preferably less than 1.5 mass % and particularly preferably less than 1 mass % of the extracted alkali metal and/or alkaline earth metal. Accordingly, the inorganic solid containing at least one alkali metal and/or alkaline earth metal is preferably an inorganic solid containing lithium and/or magnesium. Furthermore, the at least one alkali metal and/or alkaline earth metal to be extracted is therefore preferably lithium and/or magnesium, the extract containing alkali metal and/or alkaline earth metal preferably being an extract containing lithium and/or magnesium.

According to a further preferred embodiment of the method, step d) of the method according to the invention comprises at least two, preferably at least three and more preferably at least four of the processing steps mentioned. The processing steps mentioned preferably take place separately from one another in space and/or in time. However, it would also be conceivable for the processing steps to be carried out in direct succession. The properties of the solid particles can advantageously be adjusted precisely by means of a plurality of processing steps.

It would be conceivable that the residue is preferably subjected to an initial wash after the extract containing alkali metal and/or alkaline earth metal has been separated off. Additional acid or base residues and other soluble constituents are advantageously removed. The initial wash is preferably carried out with water.

According to a preferred embodiment of the method, the solid particles have a mean grain size (d₅₀, Sedigraph) in a range between 0.1 μm-5 mm, preferably between 0.1 μm-100 μm or between 100 μm-500 μm or between 500 μm-1000 μm or between 1 mm-5 mm. All grain sizes located within these ranges are also advantageously intended to be regarded as being disclosed. By virtue of the corresponding mean grain size, the solid particles can be suitable for different uses.

According to a preferred embodiment of the method, the solid particles have a specific surface area (BET) in a range from 0.01 m²/g to 300 m²/g, preferably from 0.1 m²/g to 250 m²/g and particularly preferably from 0.5 m²/g to 250 m²/g. Furthermore, all intermediate values are also advantageously intended to be disclosed. Such a specific surface area ensures particularly advantageous adsorption or absorption properties of the solid particles.

The solid particles preferably have a moisture or water content of 0-99 mass %, more preferably 1-50 mass %, particularly preferably 1-25 mass %, particularly preferably 0-1 mass % or <1 mass %. The water content can preferably be adjusted by an optional processing step of drying.

The solid particles preferably have a pozzolanic activity of >100 mg Ca(OH)₂/g, preferably >300 mg Ca(OH)₂/g and particularly preferably >500 mg Ca(OH)₂/g. This is determined according to the Chapelle test. The particles are therefore preferably hydraulically active.

According to a preferred embodiment of the method, the solid particles have a whiteness determined according to R 457 of >50%, preferably >70% and particularly preferably >80% and/or a brightness value (L* value) determined according to EN ISO 11664-4 of >60, preferably >70, more preferably >80 and particularly preferably over >90. Due to these advantageous optical values, in particular the high degree of whiteness, the solid particles are preferably suitable for use in paints.

The solid particles preferably have a density of <3.0 g/ml, preferably <2.9 g/ml and particularly preferably <2.8 g/ml or in a range between 0.5-5 g/ml, preferably between 1-4 g/ml and particularly preferably between 2-3 g/ml.

The solid particles preferably have an oil absorption value determined according to DIN EN ISO 787-5 of <200 g/g, preferably <150 g/g and particularly preferably <100 g/g or in a range between 1 g/g-300 g/g, preferably between 5 g/g-250 g/g and particularly preferably between 10 g/g-200 g/g.

The solid particles also preferably have crystalline and/or amorphous components.

The solid particles preferably comprise at least one of the chemical elements aluminium (Al), silicon (Si), oxygen (O), hydrogen (H), sodium (Na), potassium (K), lithium (Li), caesium (Cs), rubidium (Rb), magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), Cr (chromium), Mo (molybdenum), tungsten (W), manganese (mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), boron (B), gallium (Ga), indium (In), thallium (TI), carbon (C), germanium (Ge), tin (Sn), lead (Pb), nitrogen (N), phosphorus (P), arsenic (As), antimony (Sb), bismuth (Bi), sulphur (S), selenium (Se), tellurium (Te), fluorine (F), chlorine (Cl), bromine (Br) and/or iodine (1). The chemical elements mentioned can be contained in the solid particles in different proportions or mass %, with preferably values between 0-99.99 mass % being conceivable. In particular, all proportions or mass % values within the stated range are advantageously intended to be disclosed. The chemical elements are preferably contained in bound form (compound), for example as a salt, and/or in elemental form.

According to a preferred embodiment of the method, the solid particles have a silicate component and preferably an aluminium silicate component. The solid particles particularly preferably have an Al—Si—O structure. It is conceivable that the structure is preferably an aluminium silicate structure. It is also conceivable that the aluminium silicate is preferably a chain silicate, a phyllosilicate or a tectosilicate, with mixtures of the silicate types also being conceivable. The silicate component or the aluminium silicate component preferably represents the main constituent of the solid particles.

For example, in the extraction of lithium from spodumene (LiAl)[Si₂O₆] or Li₂O×Al₂O₃×4SiO₂) or petalite (LiAl)[Si₄O₁₀] or (Li₂O×Al₂O₃×8SiO₂), the lithium or Li₂O component is separated by means of the extraction step and a residue with an Al—Si—O structure (aluminium silicate) remains, corresponding to the inorganic solid containing at least one alkali metal and/or alkaline earth metal. It is conceivable that, in addition to the structural elements, at least one of the elements aluminium (Al), silicon (Si), oxygen (O), hydrogen (H), sodium (Na), potassium (K), lithium (Li), caesium (Cs), rubidium (Rb), magnesium (Mg), calcium (Ca), strontium (Sr), barium (Ba), scandium (Sc), yttrium (Y), titanium (Ti), zirconium (Zr), hafnium (Hf), vanadium (V), niobium (Nb), tantalum (Ta), Cr (chromium), Mo (molybdenum), tungsten (W), manganese (mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), boron (B), gallium (Ga), indium (In), thallium (TI), carbon (C), germanium (Ge), tin (Sn), lead (Pb), nitrogen (N), phosphorus (P), arsenic (As), antimony (Sb), bismuth (Bi), sulphur (S), selenium (Se), tellurium (Te), fluorine (F), chlorine (Cl), bromine (Br) and/or iodine (1) can be contained. These further elements originate for example from the provided inorganic solid containing at least one alkali metal and/or alkaline earth metal, and may be contamination caused by other minerals or rocks, and/or by-products from the extraction process. The chemical elements mentioned can be contained in the alkali metal-depleted and/or alkaline earth metal-depleted solid in different proportions or mass %, with values between 0.01 and 99.99 mass % being conceivable. In particular, all proportions or mass % values within the stated range are advantageously intended to be disclosed. The chemical elements are preferably contained in bound form (compound), for example as a salt, and/or in elemental form.

In step d), as a result of the processing, disruptive impurities such as heavy metals are preferably removed, the pH is adjusted to substantially neutral and/or the residue is dried and/or a desired grain size is adjusted, and corresponding solid particles are thus obtained.

In the following, the possible processing steps of step d) of the method according to the invention are presented in more detail, with these merely intended to be preferred embodiments. The processing steps mentioned are preferably intended to comprise all methods/processes known for this purpose in the prior art.

The processing in accordance with step d) is preferably carried out in a wet or a dry method or in a combination of partial steps of both methods.

The pH is preferably adjusted or neutralised. Washing can also be carried out, preferably with water. The pH value is increased, after acid leaching, using a lye or aqueous solution of this lye, such as sodium hydroxide solution NaOH, potassium hydroxide solution KOH, ammonia NH₃ and/or milk of lime. In the case of base leaching, the pH value can be reduced by means of an acid or an aqueous solution of this acid, such as hydrochloric acid HCl, nitric acid HNO₃, sulphuric acid H₂SO₄, phosphoric acid H₃PO₄, carbonic acid H₂CO₃, acetic acid C₂H₄O₂ and/or oxalic acid C₂H₂O₄.

Preference is given to not removing impurities in the form of salts which arise during the neutralisation or pH adjustment. However, it is also conceivable that the resulting impurities are removed by the neutralisation in a separate step or during one of the steps mentioned below.

In the case of wet processing, the residue is preferably separated according to the mean grain size and/or mass and/or density while still moist and other disruptive mineral impurities are preferably removed. Density separation methods, spiral separators, upcurrent classifiers, sizing methods, cyclones and/or centrifuges are preferably used for this purpose. In addition, magnetic impurities are preferably removed, for example by means of magnetic separation.

The mean grain size of the residue is then preferably adjusted as desired. This is done, for example, by means of grinding, a bead mill, a dispersion process and/or ultrasound. The mean grain size is preferably variably adjustable and depends on the later application.

Furthermore, the residue is preferably separated according to the mean grain size, it being possible to use, for example, sizing, cyclone separation, sieving, a decanter and/or a centrifuge for this purpose.

The residue is preferably dewatered and/or dried. For example, filter presses, vacuum drum filters, dewatering screens, thickening cyclones, thickeners, lamellar thickeners, centrifuges, decanters, grinding dryers and/or fluidised bed dryers are used for this purpose.

For dry processing, the residue is first preferably dewatered and dried. This is ensured, for example, by filter presses, vacuum drum filters, dewatering screens, thickening cyclones, thickeners, lamellar thickeners, centrifuges, decanters, grinding dryers and/or fluidised bed dryers.

The dried residue is preferably separated according to the mean grain size and/or mass and/or density. In addition, magnetic impurities are preferably removed, for example by means of magnetic separation. In addition, for example, density separation methods and/or electrostatic methods are used for mineral separation.

The next step in dry processing is preferably to adjust the mean grain size of the residue, for example by means of a ball mill, jet mill, pin mill and/or hammer mill.

The residue is preferably separated according to grain size. Sieving, air separation and/or cyclone separation are conceivable.

An example of dry processing preferably comprises the following processing steps: providing the residue; neutralisation with NaOH or milk of lime; dewatering; dry magnetic separation; dry grinding and air separation; packaging.

In the example dry processing, there is preferably no rewash, but instead a pH value adjustment or neutralisation. The pH value is increased, after acid leaching, using a lye or aqueous solution of this lye, such as sodium hydroxide solution NaOH, potassium hydroxide solution KOH, ammonia NH₃ and/or milk of lime. In the case of base leaching, the pH value can be reduced by means of an acid or an aqueous solution of this acid, such as hydrochloric acid HCl, nitric acid HNO₃, sulphuric acid H₂SO₄, phosphoric acid H₃PO₄, carbonic acid H₂CO₃, acetic acid C₂H₄O₂ and/or oxalic acid C₂H₂O₄. Rewashing would require the management of enormous amounts of water, which can be regionally scarce. The salt contamination caused by the neutralisation can be considered low and acceptable for the application.

More preferably, in the example dry processing, there is no wet classification before drying, since this would require large cyclones and water management.

The processing steps described do not have to be carried out in the order shown, but are variable. Further combinations and variations of the processing steps mentioned are also conceivable. All of the features disclosed for wet processing are also intended to be disclosed for dry processing and vice versa.

Transport should preferably be understood to mean any active change of location starting from the location of the extraction. For example, it is preferred to transport the residue after extraction to further processing or the like. Filling should preferably be understood to mean portioning of the residue, for example for further processing, for example filling into so-called big packs. Packaging is also understood to mean placing in a suitable vessel for sale or transport.

Furthermore, it is conceivable that the surface coating of the residue can take place physically and/or chemically and comprises, for example, hydrophobisation, silanisation and/or chemical reactions under temperature, pressure, time and optionally with the addition of further reagents.

Furthermore, the object is achieved by solid particles obtained from a residue of an alkali metal and/or alkaline earth metal extraction from an inorganic solid containing at least one alkali metal and/or alkaline earth metal, the solid particles being, according to the invention, a residue that is transported, and/or filled, and/or packaged, and/or washed, and/or dried, and/or pH-adjusted, and/or separated according to a mean grain size and/or according to a mass and/or according to a density, and/or adjusted based on a mean grain size, and/or magnetically separated, and/or calcined, and/or thermally rounded, and/or surface-coated.

According to a preferred embodiment, the solid particles comprise at least two, preferably at least three, more preferably at least four of the properties listed.

It would also be conceivable that the solid particles obtained from a residue of an alkali metal and/or alkaline earth metal extraction from an inorganic solid containing at least one alkali metal and/or alkaline earth metal include at least one, preferably at least two, more preferably at least three and particularly preferably at least four of the properties selected from a group comprising transported, filled, packaged, washed, dried, pH-adjusted, separated according to a mean grain size and/or according to a mass and/or according to a density, adjusted based on a mean grain size, magnetically separated, calcined, thermally rounded and/or surface-coated.

According to a preferred embodiment, the solid particles have a surface coating. A preferred surface coating allows properties of the solid particles to be adjusted in a targeted manner. The surface coating can preferably be a hydrophobic surface coating, which particularly preferably comprises one of the substances alkyltrimethoxysilane, alkyltriethoxysilane and/or alkylsiloxane.

According to a preferred embodiment, the solid particles have a specific surface area (BET) in a range from 0.01 m²/g to 300 m²/g, preferably from 0.1 m²/g to 250 m²/g and particularly preferably from 0.5 m²/g to 250 m²/g.

According to a preferred embodiment, the solid particles have a mean grain size (d₅₀, Sedigraph) in a range between 0.1 μm-5 mm, preferably between 0.1 μm-100 μm or between 100 μm-500 μm or between 500 μm-1000 μm or between 1 mm-5 mm.

According to a preferred embodiment, the solid particles have a whiteness determined according to R 457 of >50%, preferably >70% and particularly preferably >80% and/or a brightness value (L* value) determined according to EN ISO 11664-4 of >60, preferably >70, more preferably >80 and particularly preferably over >90. Due to these advantageous optical values or properties, in particular the high degree of whiteness, the solid particles are preferably suitable for use in paints.

The solid particles in an aqueous solvent preferably have a pH value in a range from 0 to 7.5, preferably from 0 to 6.5 and more preferably from 0 to 6 or in a range from 8 to 14, preferably from 8.5 to 14 and more preferably from 9 to 14 or from 6 to 8.

According to a preferred embodiment, the solid particles have a silicate component and preferably an aluminium silicate component. The solid particles particularly preferably have an Al—Si—O structure. It is conceivable that the structure is preferably an aluminium silicate structure. It is also conceivable that the aluminium silicate is preferably a chain silicate, a phyllosilicate or a tectosilicate, with mixtures of the silicate types also being conceivable. The silicate component or the aluminium silicate component preferably represents the main constituent of the solid particles.

According to the present invention, all of the features disclosed in relation to the solid particles according to the invention are advantageously also intended to be disclosed, mutatis mutandis, for the method according to the invention or the solid particles obtained by the method and vice versa.

In addition, the object is achieved by a use of solid particles, preferably the solid particles according to the invention and/or preferably produced according to at least one of the steps of the method according to the invention, for producing a product, preferably selected from a group comprising fillers, paints, varnishes, polymers, paper, paper fillers, release agents, free-flow agents, refractory materials, casting additives, adsorbers, absorbers, carriers, filtration additives, medical and/or agricultural products, composite materials, rubber and tyres.

The solid particles are preferably used for the production of functional fillers, in particular for paints, varnishes, polymers (thermoplastics, thermosetting plastics, elastomers), paper and/or hydraulic applications.

The solid particles are preferably used for the production of a release agent, free-flow agent, refractory material, casting additive, adsorber, absorber, carrier, filtration additive and/or paper filler.

It is also conceivable that the solid particles are used to manufacture products in the fields of medicine, agriculture and/or life science.

The solid particles are preferably used for the production of paints as an alternative to, for example, calcined kaolin, diatomite and/or precipitated silica and preferably serve as a matting agent that influences rheology and processing.

The solid particles are preferably used for the production of varnish as a new type of alternative to feldspar, nepheline and silica. Use for the production of a transparent, scratch-resistance-increasing filler for wood varnish applications is also conceivable.

The solid particles are preferably used for the production of fillers for composite materials or for the production of composite materials. The edges of the solid particles can be subjected to thermal rounding. Li residues in the solid particles, in particular if they were obtained through the processing of lithium-depleted residue, can support this process as a flux. The solid particles can preferably be used for the production of extremely white, hard, rheology-optimising fillers for composite materials.

The solid particles can preferably be used for the production of rubber or tyres as an alternative to silica or precipitated silicon dioxide (SiO₂) as an active filler.

The solid particles can preferably be used for the production of filter material for cleaning liquids, wine, beer and/or juices as an alternative to diatomite.

The solid particles can preferably be used for the production of adsorbents as an alternative to activated fuller's earth (bentonite) for oil filtration/oil purification (both mineral oils and natural oils such as coconut and olives).

The solid particles can preferably be used for the production of adsorbents for air, exhaust air and/or water purification. It is also conceivable that the solid particles can be used as an alternative to activated carbon in power plant/waste incineration waste air purification, for the production of non-combustible absorbers with an increased specific surface area (BET), in particular mercury absorbers.

The solid particles can preferably be used for the production of elastic/deformable additives (inorganic) used in casting to avoid vein formation.

The solid particles can preferably be used for the production of refractory materials (high-melting, inert).

The application or usage examples are not intended to be restricted to these; further uses or applications are also conceivable. The solid particles should in this case be suitable for the production of products.

The solid particles in the product produced therefrom preferably ensure advantageously improved matting, glossy, flame-retardant, viscosity-influencing, cost-reducing and/or mechanical properties.

In the light of the present application, the terms grain size and particle size are preferably used synonymously or interchangeably.

The invention is explained in greater detail below with reference to the following drawings. In the drawings:

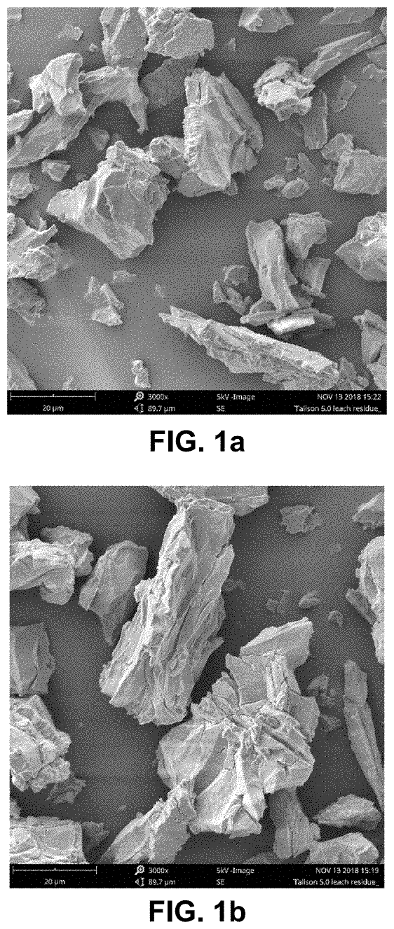

FIG. 1a, b shows a morphology of solid particles from a lithium-depleted residue (example TLR 5.0);

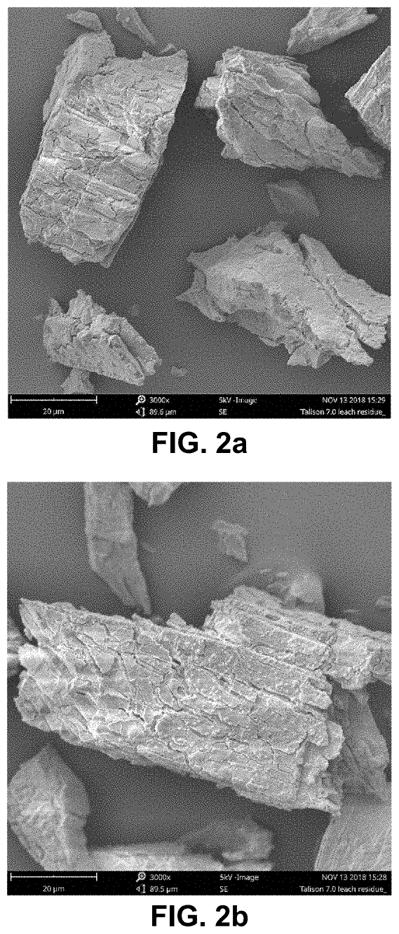

FIG. 2a, b shows a morphology of solid particles from a lithium-depleted residue (example TLR 7.0).

In FIGS. 1a and 1b, SEM images of particles of a lithium-depleted residue are shown. The particles correspond to the sample TLR 5.0 and were imaged after calcination and extraction.

In FIGS. 2a and 2b, SEM images of particles of a lithium-depleted residue are shown. The particles correspond to the sample TLR 7.0 and were imaged after calcination and extraction.

The particles of the samples TLR 5.0 and TLR 7.0 each show a splintery and irregular grain shape. In addition, pores, gaps and crevices resulting from the chemical treatment before and during the extraction can be seen, which are more pronounced with TLR 7.0 than with TLR 5.0.

### EXAMPLES

Two mineral concentrates or concentrates (the inorganic solid containing at least one alkali metal and/or alkaline earth metal) which originate from lithium extraction and substantially consist of spodumene, comprising a) 5.0 mass % of Li₂O and b) 7.0 mass % of Li₂O, were subjected to a calcination and leaching process (extraction) on a laboratory scale under the following conditions:

Roasting temperature: 1100° C.

Roasting time: 1 h

Baking temperature: 250° C.

Baking time: 1 h

H₂SO₄/spodumene: 0.3

Water/spodumene: 3:1

Washing solution/spodumene: 1:1

Extraction temperature: 90° C.

Extraction time: 1 h

After the above extraction or leaching, two lithium-depleted residues and therefrom the solid particles according to the invention were obtained, which are referred to below as TLR 5.0 and TLR 7.0 (TLR=test leach residue). The following chemical, physical and mineralogical properties were determined from TLR 5.0 and TLR 7.0, which are shown in Table 1.

TABLE 1
Physical properties and chemical composition
of samples TLR 5.0 and TLR 7.0.

| | Measurement | | |
|---|---|---|---|
| Properties | method | TLR 5.0 | TLR 7.0 |
| Mean particle size | Sedigraph | 6.2 | 5.0 |
| d₁₀ [μm] | | | |
| Mean particle size | Sedigraph | 80 | 11 |
| d₅₀ [μm] | | | |
| Mean particle size | Sedigraph | 440 | 60 |
| d₉₀ [μm] | | | |
| Whiteness [%] | R 457 | 92.9 | 92.7 |
| Yellow value [%] | EN ISO | 1.9 | 2.5 |
| | 11664-4 | | |
| L* (LAB colour space) | | 97.8 | 97.8 |
| a* (LAB colour space) | | 0.02 | 0.24 |
| b* (LAB colour space) | | 1.0 | 1.2 |
| Y (XYZ colour space) | | 94.3 | 94.4 |
| x (XYZ colour space) | | 0.3156 | 0.3162 |
| y (XYZ colour space) | | 0.3328 | 0.3331 |
| Specific surface area | | 4.8 | 11.2 |
| BET [m²/g] | | | |
| Oil absorption value | | 28 | 46 |
| (pigments/dyes) | | | |
| [g/100 g] | | | |
| Bulk density [kg/dm³] | | 0.645 | 0.315 |
| Density [g/cm³] | | 2.62 | 2.44 |
| (pycnometer, H₂O) | | | |
| pH value (soil) | | 3.1 | 4.1 |
| Lithium oxide [mg/kg] | | 1100 | 9300 |
| Rubidium oxide [mg/kg] | | 790 | 270 |
| Chapelle test | | 1100 | 920 |
| [mg Ca(OH)₂/g] | | (measure- | |
| | | ment on | |
| | | a fraction | |
| | | <63 μm) | |
| SiO₂ [mass %] | | 77.5 | 67.5 |
| Al₂O₃ [mass %] | | 18.1 | 26.4 |
| Fe₂O₃ [mass %] | | 0.06 | 0.09 |
| TiO₂ [mass %] | | 0.01 | 0.03 |
| K₂O [mass %] | | 0.55 | 0.16 |
| Na₂O [mass %] | | 0.19 | 0.03 |
| CaO [mass %] | | <0.01 | <0.01 |
| MgO [mass %] | | <0.01 | <0.01 |
| PbO [mass %] | | <0.01 | <0.01 |
| BaO [mass %] | | <0.01 | <0.01 |
| SO₃ [mass %] | | <0.01 | <0.01 |
| MnO [mass %] | | 0.04 | 0.06 |
| P₂O₅ [mass %] | | 0.03 | 0.06 |
| ZrO [mass %] | | <0.01 | 0.01 |
| GV (1025° C.) [mass %] | | 3.2 | 4.5 |

The mean particle size (d₅₀, Sedigraph) of TLR 7.0 at 11 μm is significantly finer than TLR 5.0 at 80 μm due to the processing.

The degree of whiteness (measured according to ISO, R 457) is 92% for TLR 5.0 and TLR 7.0, which is higher than, for example, kaolin calcinates at +/−90%.

The yellow value of 1.9% for TLR 5.0 and 2.5% for TLR 7.0 is very low compared to calcinates with a yellow value of approx. 3-5%.

The specific surface area (BET) increases with the fineness and, in the case of TLR 7.0, at 11.2 m²/g is lower than calcinates at about 2-3 m²/g.

The oil absorption value also increases with the fineness, with the oil absorption value of TLR 7.0 being 46 g/100 g.

The pH value is slightly acidic with pH 3.1 for TLR 5.0 and 4.1 for TLR 7.0.

TLR 5.0 and TLR 7.0 are hydraulically active and, according to the Chapelle test, at the level of medium metakaolin.

The chemical compositions of TLR 5.0 and TLR 7.0 show the remaining Al-silicate structure (Al—Si—O structure), which comes from the spodumene.

The iron content is very low at <0.1 mass % for TLR 5.0 and TLR 7.0.

The higher Li content of the concentrate of TLR 7.0 was also found in the residue; just under 1.0 mass % in TLR 7.0.

The grain size distribution of TLR 5.0 and TLR 7.0 was also determined. The values are shown in Table 2.

TABLE 2
Grain size distribution
of TLR 5.0 and TLR 7.0

| Grain | TLR 5.0 | TLR 7.0 |
|---|---|---|
| size [μm] | [wt.- %] | [wt.- %] |
| 720 | 100 | 100 |
| 630 | 98.8 | 100 |
| 500 | 92.7 | 100 |
| 400 | 82.1 | 100 |
| 315 | 66.9 | 100 |
| 200 | 57.1 | 99.9 |
| 100 | 51.6 | 98.9 |
| 63 | 46.5 | 92.4 |
| 50 | 37.9 | 72.4 |
| 40 | 37.6 | 71.9 |
| 30 | 37.5 | 70.1 |
| 25 | 37.3 | 68.3 |
| 20 | 36.3 | 64.9 |
| 15 | 32.8 | 57.8 |
| 10 | 22.4 | 39.0 |
| 8.0 | 15.2 | 27.3 |
| 6.0 | 8.2 | 15.7 |
| 5.0 | 5.3 | 10.4 |
| 4.0 | 3.2 | 6.6 |
| 3.0 | 2.0 | 3.9 |
| 2.0 | 1.0 | 2.1 |
| 1.5 | 0.9 | 1.7 |
| 1.0 | 0.4 | 0.7 |
| 0.8 | 0 | 0.1 |

The samples TLR 5.0 and TLR 7.0 were also examined by means of X-ray diffractometry (powder). It was found that both samples contain hydrogen aluminium silicate as a crystalline phase.

Furthermore, according to the X-ray structure analysis, both samples comprise quartz.

The physical properties and the chemical composition of the samples TLR 5.0 and TLR 7.0 differ. It is conceivable that the different properties are attributable to the different Li₂O contents or the associated different processing before and/or during the extraction or are attributable to an initially different chemical composition of the obtained samples TLR 5.0 and TLR 7.0.

The solid particles TLR 5.0 and TLR 7.0 were then subjected to further processing steps.

The solid particles TLR 5.0 were cleaned of magnetic components by wet and subsequent dry magnetic separation. The wet magnetic separation was carried out by means of a magnetic separator (from the company Eriez) in an aqueous suspension over a stainless steel grid matrix (approx. 1 mm mesh size) with a magnetic field strength of approx. 2 Tesla. The cleaned material was dried. The removed magnetic component was dried and then additionally cleaned using a tape magnetic separator (from the company Eriez).

The solid particles TLR 7.0 were cleaned of magnetic components by wet and subsequent dry magnetic separation. The wet magnetic separation was carried out by means of a magnetic separator (from the company Eriez) in an aqueous suspension over a stainless steel grid matrix (approx. 1 mm mesh size) with a magnetic field strength of approx. 2 Tesla.

After the magnetic separation and before the application-specific test, both dried solid particles TLR 5.0 and TLR 7.0 were sieved at 40 μm. With this procedure, the grain size classification is simulated using an air separator.

Finally, the following filler tests for use in emulsion paint in comparison to other products on the market (market product; MP) were carried out on the fraction <40 μm from the sieving of the solid particles TLR 5.0 and TLR 7.0.

The solid particles TLR 5.0 and TLR 7.0 and all other investigated materials/fillers MP 1-7 were introduced into a binder-additive mixture as the sole inorganic component (filler). No other fillers or pigments were included. The results of the filler test are summarised in Table 3.

TABLE 3
Physical properties and results of the filler test.

| Kaolin type | calcined | calcined | calcined | calcined | calcined | calcined | calcined | | |
|---|---|---|---|---|---|---|---|---|---|
| Product | MP 1 | MP 2 | MP 3 | MP 4 | MP 5 | MP 6 | MP 7 | TLR 5.0 | TLR 7.0 |
| Sedi [μm] | mass % | mass % | mass % | mass % | mass % | mass % | mass % | mass % | mass % |
| 30-45 | 0.1 | 0.6 | 2.0 | 0.0 | 0.5 | 1.1 | 0.3 | 0.1 | 2.4 |
| 20-30 | 1.0 | 2.4 | 10.7 | 0.3 | 4.4 | 8.9 | 0.7 | 8.8 | 16.2 |
| 10-20 | 3.6 | 12.2 | 46.1 | 4.5 | 16.6 | 21.1 | 3.8 | 48.3 | 47.5 |
| 6-10 | 7.0 | 21.5 | 24.8 | 11.8 | 12.2 | 14.0 | 7.0 | 28.7 | 21.1 |
| 4-6 | 7.8 | 26.4 | 8.7 | 18.2 | 8.8 | 12.1 | 11.2 | 8.5 | 7.2 |
| 2-4 | 17.1 | 30.0 | 5.9 | 34.1 | 17.0 | 20.0 | 29.8 | 1.6 | 1.4 |
| 0-2 | 63.4 | 6.9 | 1.8 | 31.1 | 40.5 | 22.0 | 47.2 | 4.0 | 4.2 |
| d50 [μm] | 1.3 | 5.0 | 13.0 | 2.9 | 2.7 | 5.2 | 2.1 | 11 | 12.8 |
| <2 μm | | | | | | | | | |
| L | 97.11 | 97.68 | 97.03 | 97.34 | 96.08 | 97.40 | 97.02 | 98.10 | 98.29 |
| a | −0.28 | −0.19 | −0.13 | −0.20 | −0.39 | 0.15 | −0.22 | −0.04 | 0.08 |
| b | 2.94 | 2.68 | 2.89 | 2.25 | 2.38 | 2.68 | 2.30 | 0.91 | 1.06 |
| Yellowness | 5.28 | 4.84 | 5.30 | 4.07 | 4.21 | 4.89 | 4.16 | 1.68 | 2 |
| Density (g/L) TDS | 2.60 | 2.45 | 2.25 | 2.67 | 2.58 | 2.58 | 2.60 | 2.60 | 2.45 |
| Whiteness | 89.0 | 90.7 | 88.9 | 90.4 | 87.0 | 85.0 | 89.5 | 94 | 94.2 |
| Oil absorption value | 51 | 50 | 55 | 66 | 52 | 25 | 53 | 48 | 46 |
| (g/100 mL) | | | | | | | | | |
| Specific surface area | 6.8 | 3.0 | 2.0 | 5.4 | 5.2 | 3.2 | 8.0 | | |
| CPVC calculated | | | | | | | | | |
| from the oil | 48 | 49 | 49 | 41 | 47 | 65 | 47 | 49 | 52 |
| absorption value | | | | | | | | | |
| Density BM | | | | | | | | | |
| Wet abrasion | | | | | | | | | |
| according to DIN | | | | | | | | | |
| ∅ wet abrasion [μm] | | | | | | | | | |
| PVC 50 | 4.6 | 6.4 | 5.6 | 6.2 | 2.8 | 2.5 | 4.5 | 15.4 | 15.7 |
| PVC 80 | 59 | 70 | 52 | 68 | 47 | 13 | 58 | n/a | n/a |
| Wet abrasion class | | | | | | | | | |
| PVC 50 | 1 | 2 | 2 | 2 | 1 | 1 | 1 | 2 | 2 |
| PVC 80 | 3 | 3 | 3 | 3 | 3 | 2 | 3 | 4-5 | 4-5 |
| Hiding power | | | | | | | | | |
| PVC 50-150 μm | 89.35 | 75.62 | 67.85 | 80.83 | 79.58 | 30.45 | 75.12 | 37.05 | 38.24 |
| PVC 80-150 μm | 97.41 | 90.93 | 84.54 | 93.68 | 96.29 | 82.41 | 94.86 | 69.43 | 66.13 |
| PVC 50-250 μm | 94.12 | 86.32 | 81.54 | 91.25 | 89.51 | 40.75 | 87.42 | 53.27 | 53.55 |
| PVC 80-250 μm | 98.88 | 95.19 | 91.29 | 97.64 | 98.58 | 89.78 | 98.21 | 79.7 | 77.39 |
| PVC 50-350 μm | 96.34 | 90.31 | 86.62 | 93.97 | 93.81 | 47.09 | 92.08 | 61.92 | 63.29 |
| PVC 80-350 μm | 99.50 | 97.40 | 94.50 | 98.81 | 99.73 | 93.58 | 98.96 | 85.78 | 84.38 |
| Layer thickness [m] | | | | | | | | | |
| at 350 μm | | | | | | | | | |
| PVC 50 | 0.000106 | 0.000121 | 0.000123 | 0.000124 | 0.000107 | 0.000106 | 0.000109 | 0.000121 | 0.000126 |
| PVC 80 | 0.000132 | 0.000152 | 0.000143 | 0.000143 | 0.000134 | 0.000107 | 0.000113 | 0.000125 | 0.00013 |
| Spreading rate | | | | | | | | | |
| [m²/l] | | | | | | | | | |
| PVC 50 for class 1 | 1.74 | 1.27 | 0.61 | 2.21 | 2.20 | −7.22 | 1.59 | −4 | −3.5 |
| PVC 80 for class 1 | 4.57 | 2.67 | 1.75 | 3.80 | 4.50 | 1.75 | 4.25 | 0.2 | 0.7 |
| PVC 50 for class 2 | 2.39 | 1.60 | 0.87 | 2.65 | 2.55 | −7.01 | 1.93 | −3.8 | −3.3 |
| PVC 80 for class 2 | 6.66 | 3.43 | 2.24 | 5.01 | 6.04 | 2.11 | 5.44 | 0.5 | 1 |
| Gloss | on contrast cards 305 μm | | | | | | | | |
| PVC 50 at 60° | 2.6 | 2.9 | 2.8 | 2.7 | 2.3 | 2.2 | 2.5 | 1.9 | 1.8 |
| PVC 80 at 60° | 2.9 | 3.4 | 3.3 | 3.1 | 2.7 | 2.4 | 2.9 | 2.4 | 2.3 |
| PVC 50 at 85° | 4.0 | 1.3 | 0.7 | 2.4 | 1.2 | 0.6 | 2.5 | 0.5 | 0.5 |
| PVC 80 at 85° | 9.6 | 4.2 | 1.4 | 7.5 | 3.5 | 0.9 | 6.9 | 0.8 | 0.6 |
| Gloss behaviour | | | | | | | | | |
| Gloss at 85° | | | | | | | | | |
| starting value | | | | | | | | | |
| PVC 50-start | 4.1 | 1.4 | 0.8 | 2.7 | 1.1 | 0.5 | 2.5 | 0.6 | 0.5 |
| PVC 80-start | 9.5 | 3.5 | 1.4 | 7.8 | 2.9 | 0.7 | 6.0 | 0.8 | 0.7 |
| Gloss at 85° | | | | | | | | | |
| final value | | | | | | | | | |
| (20 cycles) | | | | | | | | | |
| PVC 50-end | 17.4 | 3.1 | 2.5 | 6.7 | 3.3 | 1.5 | 5.9 | 2.7 | 2.2 |
| PVC 80-end | 30.3 | 8.4 | 2.6 | 21.6 | 9.1 | 1.8 | 17.0 | 2.5 | 1.9 |
| Difference | | | | | | | | | |
| PVC 50 | −13.3 | −1.7 | −1.7 | −4.0 | −2.1 | −1.0 | −3.4 | −2.1 | −1.7 |
| PVC 80 | −20.8 | −4.9 | −1.1 | −13.8 | −6.2 | −1.1 | −11.0 | −1.7 | −1.2 |
| Rheology at 25° C. | | | | | | | | | |
| (P/P) | | | | | | | | | |
| Viscosity at 6.2 s⁻¹ | | | | | | | | | |
| P/P | | | | | | | | | |
| PVC 50 | 2097 | 1488 | 1700 | 1482 | 1845 | 1571 | 1929 | 1498 | 1500 |
| PVC 80 | 2748 | 2662 | 2766 | 2524 | 2720 | 1877 | 2658 | 2111 | 2303 |
| Shear stress at | | | | | | | | | |
| 1200 s⁻¹ [Pa] | | | | | | | | | |
| PVC 50 | 432 | 331 | 347 | 354 | 409 | 297 | 348 | 319 | 395 |
| PVC 80 | 463 | 518 | 527 | 608 | 464 | 360 | 444 | 453 | 440 |
| Colour location | | | | | | | | | |
| PVC 50 | | | | | | | | | |
| L | 95.04 | 94.98 | 94.42 | 94.81 | 92.58 | 90.29 | 93.92 | 93.59 | 93.62 |
| a | −0.47 | −0.50 | −0.53 | −0.34 | −0.54 | −1.11 | −0.45 | −0.83 | −0.83 |
| b | 3.93 | 2.50 | 2.56 | 2.83 | 3.88 | 8.96 | 3.60 | 2.77 | 2.81 |
| Standard colour | 87.72 | 87.57 | 86.25 | 87.18 | 82.02 | 76.92 | 85.08 | 84.32 | 84.39 |
| value Y | | | | | | | | | |
| Yellow value | 7.09 | 4.39 | 4.50 | 5.14 | 7.08 | 16.34 | 6.55 | 4.7 | 4.77 |
| PVC 80 | | | | | | | | | |
| L | 96.70 | 96.49 | 95.56 | 96.47 | 95.22 | 93.28 | 96.33 | 94.78 | 94.74 |
| a | −0.27 | −0.29 | −0.32 | −0.18 | −0.33 | −0.27 | −0.21 | −0.45 | −0.44 |
| b | 2.75 | 1.78 | 1.84 | 2.03 | 2.46 | 5.03 | 2.11 | 1.58 | 1.64 |
| Standard colour | 91.70 | 91.19 | 88.96 | 91.14 | [symbol] 8.15 | 83.60 | 90.81 | 87.09 | 87 |
| value Y | | | | | | | | | |
| Yellow value | 4.95 | 3.14 | 3.26 | 3.69 | 4.43 | 9.41 | 3.83 | 2.69 | 2.81 |

[symbol]

indicates data missing or illegible when filed

The mean particle size d₅₀ of the solid particles TLR 5.0 and TLR 7.0 in the mixture is 11 μm and 13 μm, respectively.

The grain size distribution of the solid particles TLR 5.0 and TLR 7.0 in the mixture is comparable with the market products (MP).

The whiteness according to R 457 of the solid particles TLR 5.0 and TLR 7.0 in the mixture is approx. 94%.

The solid particles TLR 5.0 and TLR 7.0 in the mixture have an oil absorption value of 48 and 46, respectively.

The viscosity of the mixture with the solid particles TLR 5.0 and TLR 7.0 is comparatively high. This can be attributed to the particle shape or morphology.

The hiding power of the mixture with the solid particles TLR 5.0 and TLR 7.0 is low. This suggests a high colour strength in tinted formulations and better transparency in varnishes.

The matting of the mixtures with the solid particles TLR 5.0 and TLR 7.0 is high and comparable to that of the market products (MP).

Furthermore, an application-specific test (AST) was carried out. Finished paints were prepared that comprise other additives (such as additional fillers, pigments, defoamers, etc.). The only difference between the paint compositions was the fillers used, with the solid particles TLR 7.0 and other market products (MP) being used. The recipes or compositions used for the various paint compositions are summarised in Table 4. The results of the application-specific test performed are shown in Table 5.

TABLE 4
Recipes of the paint compositions produced.

| | MP 1 | MP 4 | MP 2 | MP 3 | MP 6 | MP 5 | MP 7 | TLR 7.0 |
|---|---|---|---|---|---|---|---|---|
| Water | 30.2 | 30.2 | 30.2 | 30.2 | 30.2 | 30.2 | 30.2 | 30.2 |
| Thickener | 0.5 | 0.5 | 0.5 | 0.5 | 0.5 | 0.5 | 0.5 | 0.5 |
| Dispersants | 0.4 | 0.4 | 0.4 | 0.4 | 0.4 | 0.4 | 0.4 | 0.4 |
| Defoamer 1 | 0.2 | 0.2 | 0.2 | 0.2 | 0.2 | 0.2 | 0.2 | 0.2 |
| Pigment | 12.5 | 12.5 | 12.5 | 12.5 | 12.5 | 12.5 | 12.5 | 12.5 |
| Filler 1 | 15.0 | 15.0 | 15.0 | 15.0 | 15.0 | 15.0 | 15.0 | 15.0 |
| Filler 2 | 12.5 | 12.5 | 12.5 | 12.5 | 12.5 | 12.5 | 12.5 | 12.5 |
| MP 2 | 16.5 | 0.0 | 0.0 | 0.0 | 0.0 | 0.0 | 0.0 | 0.0 |
| MP 11 | 0.0 | 16.5 | 0.0 | 0.0 | 0.0 | 0.0 | 0.0 | 0.0 |
| MP 7 | 0.0 | 0.0 | 16.5 | 0.0 | 0.0 | 0.0 | 0.0 | 0.0 |
| MP 8 | 0.0 | 0.0 | 0.0 | 16.5 | 0.0 | 0.0 | 0.0 | 0.0 |
| MP 16 | 0.0 | 0.0 | 0.0 | 0.0 | 16.5 | 0.0 | 0.0 | 0.0 |
| MP 14 | 0.0 | 0.0 | 0.0 | 0.0 | 0.0 | 16.5 | 0.0 | 0.0 |
| MP 18 | 0.0 | 0.0 | 0.0 | 0.0 | 0.0 | 0.0 | 16.5 | 0.0 |
| TLR 7.0 | 0.0 | 0.0 | 0.0 | 0.0 | 0.0 | 0.0 | 0.0 | 16.5 |
| Defoamer 2 | 0.2 | 0.2 | 0.2 | 0.2 | 0.2 | 0.2 | 0.2 | 0.2 |
| Binder (BM) | 12.0 | 12.0 | 12.0 | 12.0 | 12.0 | 12.0 | 12.0 | 12.0 |
| Sum | 100.0 | 100.0 | 100.0 | 100.0 | 100.0 | 100.0 | 100.0 | 100.0 |
| Sum of fillers | 44.0 | 44.0 | 44.0 | 44.0 | 44.0 | 44.0 | 44.0 | 44.0 |
| Ratio of filler to BM | 6.9 | 6.9 | 6.9 | 6.9 | 6.9 | 6.9 | 6.9 | 6.9 |
| w (solid) | 63.5% | 635% | 63.5% | 63.5% | 63.5% | 63.5% | 63.5% | 63.5% |

TABLE 5
Results of the application-specific test.

| | MP 1 | MP 4 | MP 2 | MP 3 | MP 6 | MP 5 | MP 7 | TLR 7.0 |
|---|---|---|---|---|---|---|---|---|
| Density [g/cm³] | 1.608 | 1.603 | 1.587 | 1.566 | 1.609 | 1.605 | 1.583 | 1.593 |
| Rheology | | | | | | | | |
| Shear stress at 1200 s⁻¹ | 551 | 531 | 505 | 456 | 394 | 492 | 467 | 437 |
| [Pa] after 1 d | | | | | | | | |
| Viscosity at 6.2 s⁻¹ | 2945 | 3190 | 3038 | 2714 | 2326 | 2886 | 2792 | 2635 |
| P/P after 1 d | | | | | | | | |
| Colour location | | | | | | | | |
| L | 97.04 | 96.90 | 96.92 | 96.63 | 96.11 | 96.38 | 96.85 | 96.40 |
| a | −0.38 | −0.38 | −0.40 | −0.43 | −0.38 | −0.41 | −0.35 | −0.47 |
| b | 2.38 | 2.21 | 2.23 | 2.19 | 2.58 | 2.18 | 2.20 | 2.25 |
| Y | 92.55 | 92.20 | 92.24 | 91.54 | 90.27 | 90.92 | 92.06 | 90.97 |
| Yellow value | 4.17 | 3.87 | 3.88 | 3.80 | 4.58 | 3.81 | 3.88 | 3.88 |
| Appearance | OK | OK | OK | OK | OK | OK | OK | OK |
| EN13300 | | | | | | | | |
| Spreading rate m²/l | 6.9 | 6.4 | 5.6 | 5.4 | 5.1 | 6.7 | 6.0 | 4.3 |
| Spreading rate class | 1 | 1 | 1 | 1 | 1 | 1 | 1 | 1 |
| Wet abrasion resistance | 27 | 29 | 15 | 7 | 4 | 11 | 16 | 7 |
| Wet abrasion class | 3 | 3 | 2 | 2 | 1 | 2 | 2 | 2 |
| Gloss 60° | 2.6 | 2.6 | 2.5 | 2.4 | 2.5 | 2.6 | 2.7 | 2.3 |
| Gloss 85° | 9.0 | 5.4 | 3.0 | 1.4 | 2.0 | 4.8 | 7.4 | 0.8 |

The application-specific test (AST) shows that paint compositions comprising the fillers produced from the solid particles TLR 7.0 have substantially similar properties to comparable products on the market. It can be seen from this that the solid particles which come from a processed residue of an alkali and/or earth alkali extraction offer properties similar to those produced on the market for this purpose.

The applicant reserves the right to claim all the features disclosed in the application documents as essential to the invention, provided that these are novel individually or in combination over the prior art. It is also noted that features which in themselves can be advantageous have also been described in the individual drawings, tables and/or images. A person skilled in the art will immediately recognise that a particular feature described in one drawing, table and/or image can also be advantageous without adopting further features from said drawing, table and/or image. A person skilled in the art will also recognise that advantages can also result from a combination of a plurality of features shown in individual or in different drawings, tables and/or images.

1-15. (canceled)

16. A method for producing solid particles from an inorganic solid containing at least one alkali metal and/or alkaline earth metal, comprising at least the following steps:
a) providing the inorganic solid containing at least one alkali metal and/or alkaline earth metal;
b) extracting the at least one alkali metal and/or alkaline earth metal from the inorganic solid containing alkali metal and/or alkaline earth metal to obtain an extract containing the alkali metal and/or alkaline earth metal and an alkali metal-depleted and/or alkaline earth metal-depleted residue;
c) separating the extract from the residue;
d) processing the residue to obtain the solid particles, wherein at least one processing step is selected from a group comprising transporting, filling, packaging, washing, drying, adjusting the pH value, separating according to a mean grain size and/or mass and/or density, adjusting a mean grain size, magnetic separating, calcining, thermal rounding and surface coating.

17. The method according to claim 16, wherein the residue is a lithium-depleted and/or magnesium-depleted residue, the residue comprising less than 7 mass % of the extracted alkali metal and/or alkaline earth metal.

18. The method according to claim 16, wherein the residue is a lithium-depleted and/or magnesium-depleted residue, the residue comprising less than 1.5 mass % of the extracted alkali metal and/or alkaline earth metal.

19. The method according to claim 16, wherein step d) comprises at least two of the processing steps mentioned.

20. The method according to claim 19, wherein the processing steps take place separately from one another in space and/or time.

21. The method according to claim 16, wherein the solid particles have a whiteness determined according to R 457 of >50%, and/or a brightness value (L* value) determined according to EN ISO 11664-4 of >60.

22. The method according to claim 16, wherein the solid particles have a whiteness determined according to R 457 of >80%, and/or a brightness value (L* value) determined according to EN ISO 11664-4 of >80.

23. The method according to claim 16, wherein the solid particles have a specific surface area (BET) in a range from 0.01 m²/g to 300 m²/g.

24. The method according to claim 16, wherein step d) comprises at least four of the processing steps mentioned.

25. The method according to claim 16, wherein the solid particles have a mean grain size (d50, Sedigraph) in a range between 0.1 μm-5 mm.

26. The method according to claim 24, wherein the processing steps take place separately from one another in space and/or time.

27. The method according to claim 16, the solid particles have a silicate component, an aluminum silicate component, or both.

28. Solid particles obtained from a residue of an alkali metal and/or alkaline earth metal extraction from an inorganic solid containing at least one alkali metal and/or alkaline earth metal,
wherein the solid particles are a residue that is transported, filled, packaged, washed, dried, pH value-adjusted, separated according to a mean grain size, mass and/or density, adjusted based on a mean grain size, magnetically separated, calcined, thermally rounded, surface-coated, or combinations thereof.

29. The solid particles according to claim 28, wherein the solid particles comprise at least two of the properties listed.

30. The solid particles according to claim 28, wherein the solid particles have a surface coating.

31. The solid particles according to claim 28, wherein the solid particles have a specific surface area (BET) in a range from 0.1 m²/g to 250 m²/g.

32. The solid particles according to claim 28, wherein the solid particles have a mean grain size (d50, Sedigraph) in a range between 0.1 μm-5 mm.

33. The solid particles according to claim 28, wherein the solid particles have a whiteness determined according to R 457 of >70% and/or a brightness value (L* value) determined according to EN ISO 11664-4 of >70.

34. The solid particles according to claim 28, wherein the solid particles have a silicate component, an aluminum silicate component, or both.

35. A product comprising the solid particles of claim 28, wherein the product is selected from the group consisting of: fillers, paints, varnishes, polymers, paper, paper fillers, release agents, free-flow agents, refractory materials, casting additives, adsorbers, absorbers, carriers, filtration additives, medical and/or agricultural products, composite materials, rubber and tyres.
